(19) United States
(12) Patent Application Publication
(10) Pub. No.: US 2026/0357608 A1
(43) Pub. Date: Nov. 12, 2026

(54) WIND TURBINE TOWER SECTION AND CONNECTION ARRANGEMENT THEREFOR

(71) Applicant: Vestas Wind Systems A/S, Aarhus N. (DK)

(72) Inventor: Nagiri Vara Prasad, Bangalore (IN)

(73) Assignee: Vestas Wind Systems A/S, Aarhus N. (DK)

(21) Appl. No.: 19/134,798

(22) PCT Filed: Dec. 21, 2023
(86) PCT No.: PCT/DK2023/050324

§ 371 Date: Jun. 2, 2025

(30) Foreign Application Priority Data
Dec. 23, 2022 (IN) 202211074925
Feb. 6, 2023 (DK) PA 2023 70069

(51) Int. Cl. E04H 12/08; E04H 12/34; F03D 13/10

(52) U.S. Cl. CPC E04H 12/085; F03D 13/112; E04H 12/342; F05B 2240/912

(57) ABSTRACT

A tower section for a wind turbine is provided. The tower section comprises an annular wall portion defining a tower section axis and having an annular connecting flange portion, wherein the annular connecting flange portion defines a first array of bolt holes. An annular flange strengthening device is located on the annular connecting flange portion, the annular flange strengthening device defining a second array of bolt holes, each bolt hole of the first array of bolt holes being alignment with a respective bolt hole of the second array of bolt holes. A plurality of mechanical fasteners are provided, each of which extends through respective bolt holes in the first and second array of bolt holes. Beneficially, the annular flange portion and the annular flange strengthening device are configured to define an annular-shaped void between them. The annular shaped void provides the annular flange strengthening device with a degree of flexibility which changes the ratio of stiffness between the flange portion and the mechanical fasteners. Beneficially, this improves the stress capacity of the interface between the mechanical fasteners which clamp the annular flange strengthening device to the annular flange connecting portion.

### TECHNICAL FIELD

The present disclosure generally relates to a methods, techniques and approaches of constructing a wind turbine, and particularly for coupling together adjacent tower sections of wind turbines at flanged connections.

### BACKGROUND

The current trend is for wind turbines to be designed ever larger in an effort to capture more energy from the wind. Wind turbines towers therefore need to be higher and constructed more strongly to accommodate the required operational loads.

Typically, wind turbine towers are constructed from steel or concrete and are formed usually from multiple tower sections which are stacked on top of one another and secured together at connecting flanges. Such a construction is well known to the skilled person.

Larger wind turbine impose greater loads on the towers which increase the stresses experienced at the flanged joints. Although tower sections could be designed with thicker material sections and flanges, this would be more costly and would increase the mass of the tower section significantly, thereby also impacting transportation issues. Therefore, it would be desirable to increase the connection strength of wind turbine towers without increasing tower mass significantly. It is against this background that the invention has been devised.

### SUMMARY OF THE INVENTION

According to one aspect of the invention, a tower section for a wind turbine is provided. The tower section comprises an annular wall portion defining a tower section axis and having an annular connecting flange portion, wherein the annular connecting flange portion defines a first array of bolt holes. An annular flange strengthening device is located on the annular connecting flange portion, the annular flange strengthening device defining a second array of bolt holes, each bolt hole of the first array of bolt holes being alignment with a respective bolt hole of the second array of bolt holes. A plurality of mechanical fasteners are provided, each of which extends through respective bolt holes in the first and second array of bolt holes.

Beneficially, the annular flange portion and the annular flange strengthening device are configured to define an annular-shaped void between them.

The annular shaped void provides the annular flange strengthening device with a degree of flexibility which changes the ratio of stiffness between the flange portion and the mechanical fasteners. This means that the annular flange strengthening device can bend or deflect slightly into the space provided by the annular void. Beneficially, this improves the stress capacity of the interface between the mechanical fasteners which clamp the annular flange strengthening device to the annular flange connecting portion.

It is envisaged that the annular flange strengthening device is most conveniently embodied as an annular plate. The annular plate may be a single part of may be formed of multiple part-annular plate portions. Said annular plate portions may be joined together in a suitable manner.

The annular-shaped void may be defined at least in part by a recess defined in the annular connecting flange portion. Alternatively, the annular-shaped void may be defined at least in part by a recess formed in the annular flange strengthening device. This may be a more convenient approach when retrofitting the strengthening device onto existing wind turbine tower sections.

The invention can also be expressed as a flange coupling arrangement for a wind turbine comprising a first or upper tower section and a second or lower tower section. The upper tower section comprises a wall portion and a first/upper connecting flange portion. The lower tower section comprises a wall portion and a second/lower connecting flange portion. The lower connecting flange portion and the upper connecting flange portion are coupled together by an array of mechanical fasteners.

A first annular flange strengthening device, which may be in the form of an annular plate, is clamped to the upper connection flange portion by the mechanical fasteners. Likewise, a second annular flange strengthening device is clamped to the upper connection flange portion by the mechanical fasteners. A first annular-shaped void is defined between the upper connecting flange portion and the upper annular flange strengthening device. Correspondingly, a second annular-shaped void is defined between the lower connecting flange portion and the lower annular flange strengthening device.

Further, the invention also embraces a method of strengthening a tower section of a wind turbine, that tower section including an annular wall portion defining a tower section axis and having an annular connecting flange portion, wherein the annular connecting flange portion defines a first array of bolt holes through which pass respective fasteners. The method includes removing at least some of the fasteners from the annular connecting flange portion; arranging an annular flange strengthening device on the annular connecting flange portion, the annular flange strengthening device defining a second array of bolt holes, each bolt hole of the first array of bolt holes being alignment with a respective bolt hole of the second array of bolt holes, and installing fasteners through respective bolt holes in the first and second array of bolt holes, thereby clamping the annular flange strengthening device to the annular flange portion. The annular connecting flange portion and the annular flange strengthening device are configured to define an annular-shaped void between them.

The method may further include forming a recess on the annular flange strengthening device prior to arranging the annular flange strengthening device on the annular connecting flange portion thereby to define the annular-shaped void when the two components are brought together. As an alternative, the annular-shaped void may be formed by forming a recess on the annular connecting flange portion prior to arranging the annular flange strengthening device on the annular connecting flange portion.

Notably, the annular flange strengthening device may be formed by a plurality of separate portions. Thus, the step of arranging the annular flange strengthening device on the annular connecting flange portion may further comprise locating a first one of a plurality of part-annular strengthening device portions on the annular connecting flange portion and securing said first part-annular strengthening device using respective mechanical fasteners and, subsequently, repeating the locating and securing step in respect of further ones of the plurality of part-annular strengthening devices.

Optional features of the aspects of the invention are set out in the dependent claims. Note that these optional features are combinable with each without limitation, save for the case that a specific limitation is discussed explicitly in the discussion that follows.

### BRIEF DESCRIPTION OF THE DRAWINGS

So that it may be more fully understood, the invention will now be described, by way of example only, with reference to the following drawings, in which like features are assigned like reference numerals, and in which:

FIG. 1 is a front view of a wind turbine tower and includes an inset panel illustrating a flange connection between adjacent sections of the tower;

FIG. 2 is a partial cut-away view illustrating the flange connection in FIG. 1 from a different perspective;

FIG. 3 is a cross section through part of the flange connection in FIG. 2;

FIG. 4a to 4d illustrate schematically a retrofit operation that is achievable with embodiments of the invention;

FIG. 5 is a plan view of a flange connection between tower sections showing a part-annular plate in accordance with the invention being applied to the connecting flange.

### DETAILED DESCRIPTION

In general terms, embodiments of the invention provide an approach to increase the strength of a flanged connection between wind turbine tower sections, which improves the strength of the overall wind turbine tower. This means that a wind turbine tower can be configured with increased strength characteristics without significantly increasing its mass. One advantage is that the approach may be applied to wind turbine towers that have already been constructed. This means that the strength of the wind turbine tower can be improved which may be useful in a retrofit operation to upgrade the power generation capacity of a particular wind turbine.

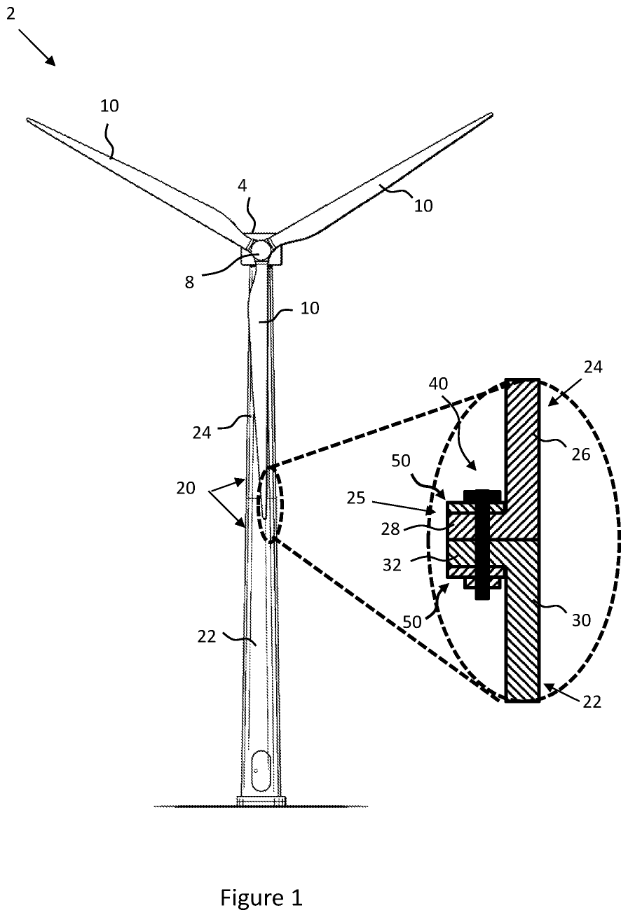

To provide context for the invention, FIG. 1 shows a typical horizontal axis wind turbine 2, that includes a nacelle 4, mounted on top of a tower 6, which supports a front facing rotor 8 comprising a plurality of coplanar blades 10. Although not shown in FIG. 1, the rotor 8 is connected to a powertrain or drivetrain housed within the nacelle 4. The drivetrain comprises components required to convert rotation of the rotor 8 into electricity, including a generator, a gear system and a controller, although these components are not shown in FIG. 1 or described in detail for brevity. Although a horizontal-axis wind turbine is shown in FIG. 1, which is a common configuration of wind turbine, it should be noted that the invention may be applicable to other wind turbine configurations.

Typically the tower 6 may be made from steel or concrete, the choice of which depends on many factors such as expected loading conditions, hub height, and location, to name a few examples. Hybrid towers of concrete and steel are also known.

The tower is constructed from annular or tubular tower sections 20, as can be seen in FIG. 1. Due to the slight tapering of the tower 6, each of the annular tower sections are slightly frustoconical, in this example. In the illustrated example, the annular tower sections 20 can be considered to be entirely, or mostly, made of steel which is a common material of construction for wind turbine towers.

In the illustrated wind turbine 2, there are two tower sections, comprising a lower tower section 22 and an upper tower section 24. Note that the tower 6 may comprise more than two tower sections, for example between three and ten tower sections.

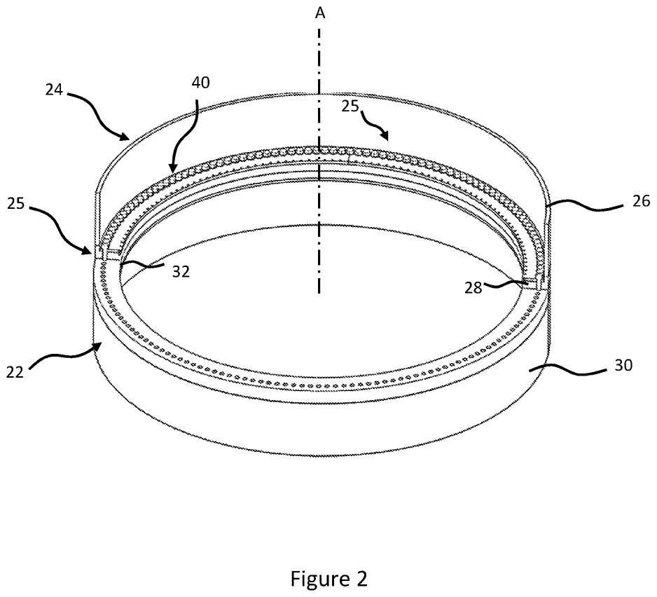

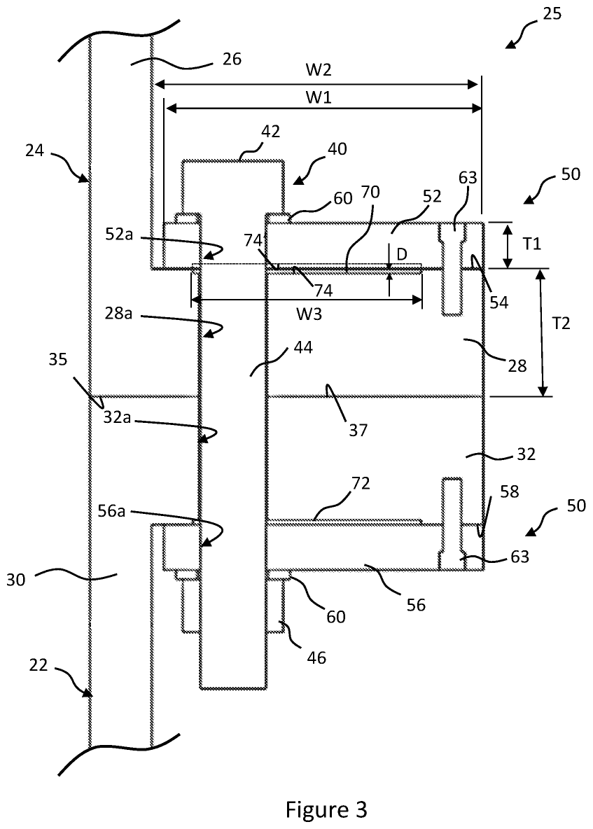

Each of the tower sections 20 are connected together by way of a flanged connection or ‘coupling’ 25. A portion of a flanged connection 25 between the lower tower section 22 and the upper tower section 24 can be seen in the inset panel in FIG. 1, and also in FIGS. 2 and 3, to which reference will now also be made.

As can be seen, the upper tower section 24 comprises an annular wall portion 26 which terminates at its lower end at a first annular connecting flange portion 28. Likewise, the lower tower section 22 comprises an annular wall portion 30 which terminates at its upper end in a respective second annular connecting flange portion 32. Such flanged connecting portions may also be referred to as L-flanges due largely to their cross sectional shape, and are generally known in the art. Other possibilities are generally T-shaped flanged connections in which a flange extends radially inwards from its respective wall portion and a flange also extends radially outwards from the respective wall portion. T-shaped flanges are also known in the art. As illustrated, the flange portions are integral with the wall portions although in principle the flange portions may be separate to the wall portions and welded thereto to form unitary components.

The upper and lower tower sections 24,22 define a central tower axis A. Moreover, the respective wall portions 26,30 extend about and are generally aligned parallel to the tower axis A.

With respect to the upper tower section 24, it will be noted that the first annular connecting flange portion 28 extends in a direction that is generally perpendicular to the annular wall portion 26. Thus, the annular wall portion 26 and the first annular connecting flange portion 28 define an L-shape in a vertical cross section, as shown. In the illustrated example, the first and second annular flange connection portions 28,32, join with each other at respective contact faces 35,37.

Similarly, with respect to the lower tower section 22, it will be noted that the second annular connecting flange portion 32 extends in a direction that is generally perpendicular to the annular wall portion 30. Thus, the annular wall portion 30 and the second annular connecting flange portion 32 define an L-shape in a vertical cross section, as shown.

A circular array of mechanical fasteners 40 in the form of bolts extend circumferentially about the flanged connection 25 and serve to join together the first annular connecting flange portion 26 and the second annular connecting flange portion 32. As shown in FIG. 3, the mechanical fasteners 40 are headed-bolts that are T-shaped in cross section thereby defining an upper bolt head 42 that is integral to shank 44. Respective nuts 46 are secured on shank 44 of the bolts 40 and tightened suitably to join the flanged connection 25. In principle the diameter of the tower section may be any size, but the invention is envisaged to be most suited to large-diameter tower sections in which the ‘bolt circle diameter’ or BCD of the fasteners is in excess of 3 m, for example between 3 m and 10 m, and more preferably between 3.5 m and 8 m.

It is also customary to turn the mechanical fasteners 40 upside down, so the bolt heads 42 are below the second annular connecting flange portion 32 and the nuts 46 are above the first annular connecting flange portion 28. Also, the mechanical fasteners 40 may instead be in the form of stud bolts having no fixed heads but first and second removable nuts, as would be well understood by the skilled person.

The flanged connection 25 between the tower sections 22,24 also includes a strengthening arrangement 50 that is configured to be located between the mechanical fasteners 40 and the annular connecting flange portions 28,32. As will be described, the strengthening arrangement 50 acts to modify the stiffness ratio between the material of the fasteners 40 and the material of the annular flange connecting portions 28,32. One way in which it achieves is be being selected as a material that has a Young's Modulus between that of the material of the fasteners 40 and the annular connecting flange portions 26,32. Another way in which this effect may be achieved is to have a geometry that imparts structural flexibility at the interface between the fasteners 40 and the annular connecting flange portions 28,32.

Although the general configuration of the flanged connection 25 is shown in FIGS. 1 and 2, the flanged connection 25 is shown in more detail also in FIG. 3.

The strengthening arrangement 50 in the illustrated embodiment comprises a pair of annular flange strengthening devices 52,56 that are positioned to sandwich the flanged connection 25, one on each side.

In a further non-illustrated embodiment the strengthening arrangement 50 comprises a single annular flange strengthening device 52,56 that are positioned on one of the sides of the flanges connection 25.

The pair of annular flange strengthening devices therefore comprise a first (upper) annular flange strengthening device 52 located on an upper surface 54 of the first annular connecting flange portion 28 and a second (lower) annular flange strengthening device 56 located on a lower surface 58 of the second annular connecting flange portion 32. In the illustrated example, the annular flange strengthening devices 52,56 are in the form of relatively flat plates and they will be referred to as ‘plates’ from now on for brevity. However, it should be appreciated that it is not essential that the annular plates 52,56 must strictly be in the form of plates. Note, also, that in the specific example described here, the annular plates 52,56 are single components that are circular in form, when viewed in plan so as to be complementary to the shape of the flanged connection 25. However, it should be appreciated that each of the annular plates 52,56 may also be made up of part-annular sections rather than being a unitary component.

The upper annular plate 52 is seen in partial cut away form on FIG. 2. Note that it is envisaged that the upper and lower annular plates 52,56 would have the same or comparable outer dimensions, although this does not exclude some dissimilarity.

In this form, therefore, the upper and lower annular plates 52,56 in effect sandwich the first and second annular connecting flange portions 28,32 between them. As will be seen particularly clearly in FIG. 3, each of the annular plates 52,56 defines a respective bolt hole array 52a,56a. Each of the bolt holes in the bolt hole array 52a,56a are aligned with respective bolts holes in the bolt hole arrays 28a, 32a defined in the first and second connecting flange portions 28,32.

The mechanical fasteners 40 therefore pass through the aligned bolt holes in the annular plates 52,56 and the first/second connecting flange portions 28,32 to join those components together. As will be seen in FIG. 3, bushes, shims or washers 60 are provided as a load displacement means between the ends of the mechanical fasteners 40 and the mating faces of the annular plates 52,56.

As a temporary fixing means, auxiliary mechanical fasteners 63 may be provided to fix the respective annular plates 52,56 to the annular connecting flange portions 32 before the main fasteners 40 are applied.

As can be seen in FIG. 3, a first annular void 70 is defined between the first annular plate 52 and the first annular connecting portion 28. Likewise, a second annular void 72 is defined between the second annular plate 56 and the second annular connecting portion 32.

Each of the first annular void 70 and the second annular void 72 can be considered to be identical in the illustrated embodiment so only one of them will be described in further detail for the sake of brevity. Although it will be understood that the description will apply to both annular voids 70,72.

On this basis, and referring to the upper of the two annular voids 70,72 as illustrated in FIG. 3, it will be noted that the first annular void 70 is defined at least in part by the first connecting flange portion 28 and/or at least in part by the first annular plate 52. In this particular embodiment, the first annular void 70 is provided its shape by an annular groove, recess or channel 74 that is defined in the upper surface 54 of the first connecting flange portion 28.

As will be appreciated from FIG. 3, the annular groove 74 is relatively wide, when considered in the radial direction, but shallow when considered in the depth direction along the tower axis A. The dimension of the annular groove 74 in the radial direction is less than the corresponding dimension of the annular plate 72. Therefore, the annular plate 72 overlaps, or straddles, over the top of the annular void 74. The position of the annular void 70 underneath the annular plate 52 means that the annular plate 52 is able to flex slightly during the cyclical loading on the tower so as to bend or deflect into the space provided by the annular void 70. Therefore, the relative hard high-strength bolt steel of the mechanical fastener 40 is provided with a relatively resilient mounting point as it bears against the respective annular plate 52. Therefore, it is believed that the relative flexibility of the annular plate 52 provides a stress relief function compared to the known approach of simply bolting the mechanical fasteners 40 to the annular connection flange portions 28,32 directly.

As will be appreciated from FIG. 3, the annular plate 52 has a dimension in the radial direction, i.e its width dimension shown here as W1, that is close to but slightly less than that of the width of the adjacent annular connection flange 28, shown here as W2. It is envisaged that in some examples the width of the annular plate will be more than 80% of the width of the annular connection flange 28, although currently it is preferred that some clearance is provided between the annular plate 52 and the wall portion 26 to account for fillets and other manufacturing tolerances in the corner point between the wall portion 26 and the connecting flange portion 28.

Similarly, the width W3 of the annular void 70 is relatively large with respect to the width W2 of the annular connecting flange portion 28. As shown here, the width W3 of the annular void 70 is greater than 30%, preferably greater than 50% and, more specifically, is approximately 70%, of the width of the annular connecting flange portion 28. In some embodiments, the width W3 of the annular void 70 is such that it extends beyond the radial extend of the washers 60.

As can be seen in the Figures, the annular void 70 is shallow in its depth dimension taken along the tower axis A. It is currently envisaged that the cross sectional shape of the annular void 70, taken in the radial direction is substantially rectangular, and uniform about the entirety of the annular void 70, and that the depth is less than 10 mm. In some examples, the depth is between 5 mm and 10 mm and in other examples the depth is less than 5 mm, for example between 2 mm and 4 mm.

From the above discussion, it will be appreciated that the cross-sectional shape of the annular void 70 is relatively wide and shallow. Therefore, the ratio of the depth of the annular-shaped void to a radial width W3 of the annular void 70 may be between 1:30 and 1:60.

As will also be appreciated from viewing FIG. 3, the annular plate 52 is configured so that it has a thickness T1 that is less than the thickness T2 of the annular flange connecting portion 28. The thickness T1 of the annular plate is preferably less than 50% and more preferably less than 25% of the thickness T2 of the annular flange connecting portion 28.

It should be emphasised at this point that although in the illustrated embodiment the annular void 70 is defined by the annular groove 74 that is defined in the annular connecting flange portion 28, the annular void 70 may also be defined by a groove machined in the underside of the annular plate 52 instead, or a combination of grooves formed complementarily in the annular connecting flange portion 28 and the annular plate 52. An alternative annular groove formed in the annular plate is shown at 74′ in FIG. 3.

A significant benefit of the invention is that the provision of the annular plate with the underlying annular void means that the strength of the flanged connection 25 between tower sections 22,24 is enhanced without increasing the mass and size of the flange connections. Indeed the inventors believe that a 10% to 15% load capacity improvement is achievable with this approach.

The principles of the invention can also be applied to existing wind turbines. For example, it may be desirable to retrofit an existing wind turbine with a flange strengthening arrangement 50 in accordance with examples of the invention in order to increase the load capacity of the flanged connections within the wind turbine tower.

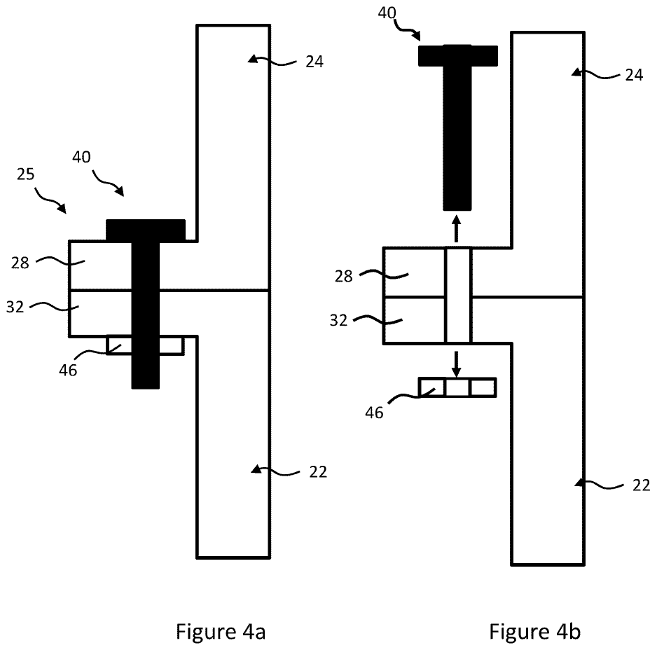

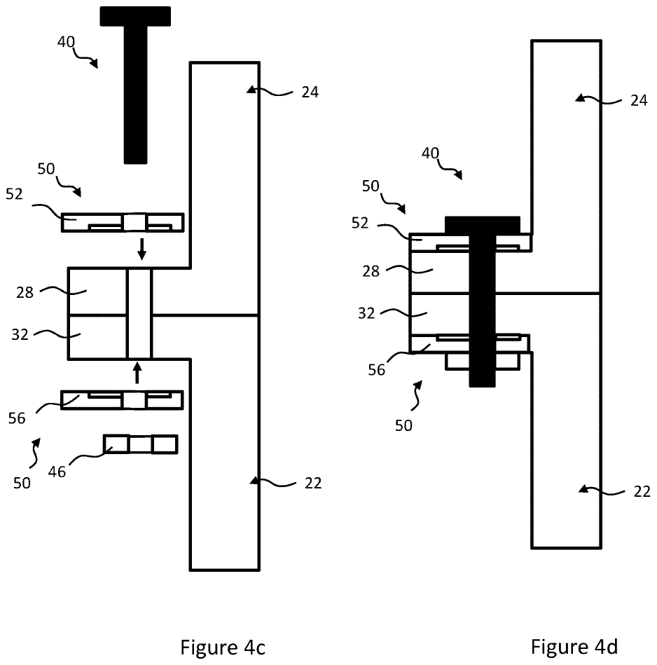

Such a retrofit process for strengthening a wind turbine tower is shown in FIGS. 4a to 4d. The general configuration of the tower sections in FIGS. 4a to 4d are comparable to those shown in FIGS. 2 and 3. Therefore, the same reference numerals will be used to refer to corresponding parts, and a full discussion of each component part will not be repeated for the sake of brevity.

As can be seen in FIG. 4a, a conventional flanged connection 25 is provided between a lower tower section 22 and an upper tower section 24.

The upper tower section 24 has respective annular connecting flange portion 28 which is mated to respective annular connecting flange portion 32 of the lower tower section 22 and clamped thereto by an array of mechanical fasteners 40.

In order to perform the method for strengthening the flanged connection 25, a first step is to remove the array of mechanical fasteners 40, as is illustrated in FIG. 4b. Here, a lower one of the nuts 46 is removed from the fastener 40 so that the fastener 40 can be extracted from the corresponding bore in the upwards direction.

It is envisaged that the fastener extraction process would be repeated for a group of several fasteners that extend around a predetermined arc of the flanged connection 25, for example between thirty to ninety degrees of arc. Once a predetermined number of fasteners 40 have been removed, an annular plate can be fitted to the flanged connection 25 which extends about a corresponding degree of arc.

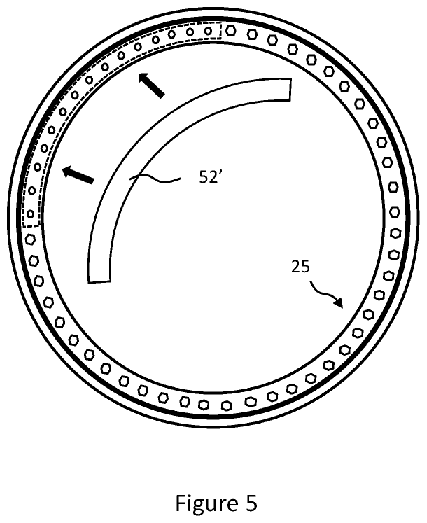

This is illustrated in FIG. 5 which shows a flanged connection 25 in plan view with a first sub-group 80 of the mechanical fasteners 40 having been removed. A part-annular plate portion 52′ may then be offered up to the flanged connection 25 and placed into position as shown by the dashed lines. Here, the part-annular plate portion 52′ is one of four such plate portions (the other three are not shown) which together form four quadrants of a completed annular plate 52 (not shown). The separate part-annular plate portions 52′ may be coupled together in some suitable way such as by way of connecting brackets or similar measures.

Forming annular plates 52 in this way from multiple part-annular plate portions 52′ provides a convenient way to retrofit an annular plate onto the flanged connection 25 for the purposes of strengthening the coupling without having to remove all of the mechanical fasteners 40 from the connection flange 25 and thus without having to dismantle the tower section or having to support the tower section with a crane during the operation. Therefore, a staged retrofit may be achieved which is beneficial because at least some mechanical fasteners 40 remain engaged with the flanged connection 25 and suitably tensioned at all times.

Returning to FIG. 4c, here is shown the flanged connection 25 with upper and lower part-annular plate portions 52, 56 being placed into position. Although not shown here, temporary or permanent fasteners 63 (not shown in FIGS. 4a-d) may be used like those shown in FIG. 3 in order to hold the part-annular plate portions 52,56 to the flanged connection 25 before the mechanical fasteners 40 are installed.

FIG. 4d shows the flanged connection 25 having the upper and lower part-annular plate portions 52,56 clamped to the upper and lower connection flange portions 28,32 by the mechanical fasteners 40.

In the above discussion, various alternative examples to the illustrated embodiments have been mentioned. Other variants and examples would be apparent to the skilled person.

For example, in the above discussion the strengthening arrangement 50 has been described as including upper and lower annular plates 52,56 which are clamped to upper and lower annular connection flanges 28,32, respectively. Such an arrangement is understood to be useful for the flanged connection 25 between two tower sections 20,22,24 in a column of tower sections. However, it is envisaged that the strengthening arrangement 50 may include only a single one of the annular plate 52,56. This may be because one of the annular flange portions of the flanged connection is larger and therefore stronger than the other annular flanged portion so only one of them requires strengthening in a manner of the invention.

1. A tower section for a wind turbine, comprising:
an annular wall portion defining a tower section axis and having an annular connecting flange portion, wherein the annular connecting flange portion defines a first array of bolt holes;
an annular flange strengthening device located on the annular connecting flange portion, the annular flange strengthening device defining a second array of bolt holes, each bolt hole of the first array of bolt holes being alignment with a respective bolt hole of the second array of bolt holes,
a plurality of mechanical fasteners, each of which extends through respective bolt holes in the first and second array of bolt holes,
wherein the annular flange connecting portion and the annular flange strengthening device are configured to define an annular-shaped void between them.

2. The tower section of claim 1, wherein the annular-shaped void is defined at least in part by a recess defined in the annular connecting flange portion.

3. The tower section of claim 1, wherein the annular-shaped void is defined at least in part by a recess formed in the annular flange strengthening device.

4. The tower section of claim 1, wherein the annular-shaped void extends in a radial direction for greater than 30%.

5. The tower section of claim 1, wherein the annular flange strengthening device has a thickness defined along the tower section axis, wherein the thickness of the annular plate is less than 50%.

6. The tower section of claim 1, wherein the annular-shaped void has a depth along the tower section axis, wherein the depth is less than 10 mm.

7. The tower section of claim 1, wherein the annular-shaped void has a depth along the tower section axis, wherein the depth is less than 5 mm.

8. The tower section of claim 1, wherein the ratio of the depth of the annular-shaped void to a radial width of the annularly-shaped void is between 1:30 and 1:60.

9. The tower section of claim 1, wherein the annular flange strengthening device is in the form of an annular plate.

10. The tower section of claim 10, wherein the annular plate is formed from a plurality of part-annular plate portions.

11. A method of strengthening a tower section of a wind turbine, that tower section including an annular wall portion defining a tower section axis and having an annular connecting flange portion, wherein the annular connecting flange portion defines a first array of bolt holes through which pass respective fasteners;
wherein the method includes:
removing at least some of the fasteners from the annular connecting flange portion;
arranging an annular flange strengthening device on the annular connecting flange portion, the annular flange strengthening device defining a second array of bolt holes, each bolt hole of the first array of bolt holes being alignment with a respective bolt hole of the second array of bolt holes,
installing fasteners through respective bolt holes in the first and second array of bolt holes, thereby clamping the annular flange strengthening device to the annular connecting flange portion;
wherein the annular flange connecting portion and the annular flange strengthening device are configured to define an annularly-shaped void between them.

12. The method of claim 11, wherein the method includes:
forming a recess on the annular flange strengthening device prior to arranging the annular flange strengthening device on the annular connecting flange portion.

13. The method of claim 11, wherein the method includes:
forming a recess on the annular connecting flange portion prior to arranging the annular flange strengthening device on the annular connecting flange portion.

14. The method of claim 11, wherein arranging the annular flange strengthening device on the annular connecting flange portion comprises:
locating a first one of a plurality of part-annular strengthening device portions on the annular connecting flange portion,
securing said first part-annular strengthening device using respective mechanical fasteners, and
subsequently, repeating the locating and securing step in respect of further ones of the plurality of part-annular strengthening devices.

15. The method of claim 11, wherein the annular flange strengthening device comprises an annular plate.
